(19) United States
(12) Patent Application Publication
(10) Pub. No.: US 2009/0022889 A1
(43) Pub. Date: Jan. 22, 2009

(54) Process of making a bonding agent to bond stucco to plastic surfaces

(76) Inventors: John Paul Schofield, Stafford, TX (US); Janet Ellen Schofield, Stafford, TX (US)

Correspondence Address: Janet Schofield, 1847 Terrence Drive, Stafford, TX, 77477, US

(21) Appl. No.: 12/217,207

(22) Filed: Jul. 2, 2008

Related U.S. Application Data
(60) Provisional application No. 60/959,619, filed on Jul. 16, 2007.

(51) Int. Cl. B05D 1/36

(52) U.S. Cl. 427/203

(57) ABSTRACT

A method of making a bonding agent to bond stucco to smooth plastic articles, specifically plastic rocks, by coating the plastic article with a water-based coal tar or asphalt emulsion, putting dry sand over the wet emulsion by hand sprinkling or spraying the sand onto the coated surface of the article, or rolling the article in the sand, allowing the sand coated article to dry thoroughly, applying a wet stucco over the dry, sand coated layer, and allowing the stucco coated article to dry.

### CROSS-REFERENCE TO RELATED APPLICATIONS

This application claims the benefit of provisional patent application Ser. No. 60/959,619 filed Jul. 16, 2007 by the present inventors.

This application uses the plastic rock disclosed in our U.S. Pat. No. 7,115,178 granted Oct. 3, 2006.

### FEDERALLY SPONSORED RESEARCH

Not Applicable

### SEQUENCE LISTING OR PROGRAM

Not Applicable

### BACKGROUND OF THE INVENTION

1. Field of the Invention

This invention generally relates to a method of making a bonding agent that will bond stucco to plastic surfaces, specifically to plastic rocks.

2. Prior Art

Stucco is a material made of sand, cement, and water. Stucco is applied wet and hardens to a very dense solid. It is almost impossible to get stucco to adhere to smooth plastic surfaces.

The present invention provides a bonding agent that bonds wet stucco to smooth plastic, especially to plastic rocks, by using sand in conjunction with a common pavement sealer or coating.

The patent which the present inventors own, U.S. Pat. No. 7,115,178 (2006), to Schofield, uses a bonding agent of anchor cement, sand, and a concrete bonding adhesive with acrylic fortifier to bond the texturing agent to a plastic rock.

The bonding agent disclosed in this application is more economical, faster and easier to use, and provides a stronger bond. It is also more environmentally friendly because it uses a water-based product.

Adhesive compositions used on artificial rocks usually involve resinous compositions applied to the substrate or mold and do not address bonding stucco to the substrate.

U.S. Pat. No. 4,734,302 (1988), to Baskin discloses a curable, resinous composition that is applied to a substrate, then coated with a fine particulate matter and contacted with an implement before the composition cures to produce a surface simulating natural stone. No mention is made of bonding stucco to the substrate.

U.S. Pat. No. 3,836,619 (1974), to Volent also discloses an artificial stone where a gel coat is applied to a molded plastic, and a sand layer is locked onto the surface of the gel coat. The sand layer is the final layer and is not used to bond a stucco layer to the mold.

U.S. Pat. No. 4,385,088 (1983), to Baskin uses liquid epoxy resin to coat a plastic rock-like form. Then hard sand-grain-sized particles are sprayed over the resin. Again, the sand is the final layer, and no mention is made of adhering stucco to the article.

U.S. Pat. No. 5,543,100 (1996), to Kluh et al also discloses coating a plastic rock blank with a resin and sand. Here again, the sand is the final step in the process and is not used to bond stucco to the artificial rock.

The prior art discloses many adhesion promoters that stick to plastic, for example in U.S. Pat. No. 5,973,045 (1999), to Dowling et al, U.S. Pat. No. 7,122,592 B2 (2006), to Wentworth et al, and U.S. Pat. No. 7,371,464 B2 (2008), to Sherman et al.

However, none of these inventions are used to bond stucco to plastic and do not use sand.

In the construction industry bonding agents have been used to bond concrete or cementitious mixes to old, already set concrete and other materials, but not to plastic, and they do not use sand as described in the present invention.

Pavement sealers and coatings have been used to coat and seal asphalt or concrete driveways, and as primers to bond other coatings to concrete or asphalt surfaces. None of these products have been used in conjunction with sand to bond stucco to plastic surfaces.

### OBJECTS AND ADVANTAGES

Accordingly, several objects and advantages of our invention are to make a bonding agent that will bond stucco to smooth plastic surfaces, especially plastic rocks.

Another object is to provide a stronger bond for the named adherents than has been previously known.

A further object is the ease of application of the bonding agent.

Also, the bonding agent disclosed is economical and discloses a new use for two common materials, namely sand and asphalt or coal tar emulsion.

### SUMMARY

The present invention pertains to a process of making a bonding agent to bond stucco to smooth plastic surfaces, especially plastic rocks.

In accordance with this invention, the process involves using two common materials to create the bonding agent.

A liquid coal tar or asphalt emulsion is put on a plastic item. The emulsion may be sprayed on or brushed on the item. If the surface is flat, the emulsion may be rolled on. In the present embodiment, the plastic item is rock shaped, and use of a water based asphalt emulsion is preferred as it is more environmentally friendly than the coal tar based coatings.

Immediately after the emulsion is applied to the surface of the plastic item, the item is sprayed with sand, or rolled in sand, or has sand hand thrown onto it. As the emulsion dries, the sand sticks to it. This makes a perfect base on which to apply the wet stucco. After the stucco has set up, (partially dried), it is recommended that the stucco be kept damp, (cured), for one to two days after it has been applied to the plastic rock.

When the stucco dries it is strongly adhered to the sandpaper-like base.

Thus the bonding agent herein described is economical, easy to make and apply, and provides a strong bond between the plastic shaped rock or item and the stucco. The bonding agent of this invention proposes a new and unexpected use for a pavement sealer or coating and sand.

### DETAILED DESCRIPTION ACCORDING TO THE PREFERRED EMBODIMENTS OF THE PRESENT INVENTION

A plastic item, preferably a rock shaped plastic item, is coated with a water-based pavement coating or sealer. The coating is sprayed on, or brushed on, or rolled on the item. The coating may be asphalt or coal tar based. The asphalt-based product is preferred, as it is more environmentally friendly.

The article thus coated is immediately sprayed with sand, or rolled in sand, or has sand hand sprinkled onto it. The sand may be fine, medium, or coarse grained.

Once the emulsion with the embedded sand is dry, it forms a sandpaper-like surface on the plastic item.

Wet stucco is now applied to the sandpaper-like base on the plastic item.

After the stucco has set up, (been allowed to dry for four to eight hours), it is cured, (kept damp), for one to two days after it is applied to the plastic item.

As the stucco dries it becomes strongly bonded to the plastic article, preferably a plastic shaped rock, by the coating and sand base.

We claim:

1. A process of making a bonding agent to bond stucco to smooth plastic by:
(a) coating a plastic article with a water-based asphalt or coal tar emulsion
(b) applying sand over the still wet coating.
(c) allowing the sand coated surface to thoroughly dry.
(d) applying wet stucco over the dry, sand coated surface.
(e) allowing the stucco to dry thoroughly

2. A method as claimed in claim 1a where the emulsion coating is applied with a brush, sprayed on, or rolled on, the plastic article.

3. A method as claimed in claim 1b where the sand is applied to the coating by spraying, or hand sprinkling, or rolling the coated article in the dry sand.
